(19) United States
(12) Patent Application Publication
(10) Pub. No.: US 2010/0308584 A1
(43) Pub. Date: Dec. 9, 2010

(54) INTEGRATED WIND TURBINE CONTROLLER AND INVERTER

(75) Inventors: Colin Edward Coates, New South Wales (AU); Alison Ruth MacReady, New South Wales (AU); David Howe Wood, New South Wales (AU)

Correspondence Address: BANNER & WITCOFF, LTD., TEN SOUTH WACKER DRIVE, SUITE 3000, CHICAGO, IL, 60606, US

(73) Assignee: NEWCASTLE INNOVATION LIMITED, Callaghan (AU)

(21) Appl. No.: 12/528,430

(22) PCT Filed: Feb. 22, 2008
(86) PCT No.: PCT/AU2008/000239

§ 371 Date: Aug. 24, 2010

(30) Foreign Application Priority Data
Feb. 26, 2007 (AU) 2007900972

(51) Int. Cl. H02P 9/04; H02M 5/42

(52) U.S. Cl. 290/44; 363/34

(57) ABSTRACT

The present invention relates to a method and apparatus for power generation, and in particular a method and apparatus for the control of electrical power generation for use primarily with wind turbines. A method of electrical power generation is described including the steps of: receiving power in the form of alternating current; rectifying said alternating current power to direct current power; control said direct current power to produce controlled direct current power; and inverting said near constant direct current power to produce alternating current.

### FIELD OF THE INVENTION

The present invention relates to a method and apparatus for power generation, and in particular a method and apparatus for the control of electrical power generation for use primarily with wind turbines.

The invention has been developed primarily for use with wind turbine apparatus that produce less than 20,000 Watts of power. However, it will be appreciated that the invention is not limited to this power rating or particular field of use.

### BACKGROUND OF THE INVENTION

Any discussion of the prior art throughout the specification should in no way be considered as an admission that such prior art is widely known or forms part of the common general knowledge in the field. In particular the references cited throughout the specification should in no way be considered an admission that such art is prior art, widely known or forms part of the common general knowledge in the field.

Standard three phase alternating current (AC) motor drive circuits commonly consist of power electronic components that are obtained as integrated modules. Many power electronic manufacturers (eg. Semikron, EUPEC) also produce customised gate drive circuits (for switching the inverter power switches) to suit their integrated power modules. Indeed, if one wants to produce their own drive using these components the problem can be reduced to designing a controller to drive the power electronics gate drive circuits.

In apparatus for low power wind turbine power generation the standard methodology for conversion of mechanical energy to electricity is to use the turbine to drive either a permanent magnet or induction generator. The generator supplies a battery charger circuit and ac electrical power is obtained from the batteries using a separate inverter circuit. Both the battery charger and inverter circuits require separate dc/dc conversion stages increasing the cost and power losses associated with this type of system. The term low power in relation to wind turbines is typically associated with apparatus that produce less than 20,000 Watts of electrical power.

The separation of the battery charger circuit, batteries and ac electrical power generating circuit is costly and inefficient. This is particularly the case for low power applications.

### OBJECT OF THE INVENTION

It is an object of the present invention to overcome or ameliorate at least one of the disadvantages of the prior art, or to provide a useful alternative.

It is an object of the invention in its preferred form to provide a cost effective alternative apparatus for electrical power generation for use with low power wind turbines.

### SUMMARY OF INVENTION

According to the invention there is provided a method of electrical power generation including the steps of:
(a) receiving power in the form of alternating current;
(b) rectifying said alternating current power to direct current power;
(c) control said direct current power to produce controlled direct current power; and
(d) inverting said near constant direct current power to produce alternating current.

Preferably the method including the step of applying a braking resistor to the controlled direct current power. More preferably the method includes the step of storing or supplying controlled direct current power through a bi-directional direct current to direct current converter, wherein the two ports of the bi-directional direct current to direct current converter are separately connected to batteries and the controlled direct current power. Most preferably the method includes the step of: filtering the produced alternating current.

Preferably the method is used as a wind turbine controller.

According to another aspect of the invention there is provided an electrical power generator apparatus including:

a power generating means;

a rectifier module, coupled to said power generating means;

a boost converter module, coupled to said rectifier module; and

a single-phase inverter module, coupled to said boost converter module.

Preferably the boost converter module is constructed from a dynamic braking portion of a motor drive circuit. More preferably the single-phase inverter module is constructed from a standard motor drive inverter circuit.

Preferably the apparatus further includes a brake resistor. More preferably the brake resistor is coupled to the standard motor drive inverter circuit.

Preferably the apparatus further including an output filter.

According to another aspect of the invention there is provided an electrical power generator apparatus including:

power generating means

rectifier module;

direct current controller module; and

inverter module;

wherein said power generating means is coupled to said rectifier module and is configured to supply power in the form of input alternating current to said rectifier module; wherein said rectifier module is coupled to said direct current controller module and is configured to convert said input alternating current to unregulated direct current; wherein said direct current controller module is coupled to said inverter module and is configured to convert said unregulated direct current to regulated direct current; wherein said inverter module is configured to convert said regulated direct current to regulated alternating current.

Preferably the apparatus modules substantially consist of standard alternating current motor drive modules.

Preferably the apparatus produces power from wind turbines. More preferably the power generating means is an induction generator.

By reconfiguring standard AC motor drive power electronic modules, an integrated wind turbine controller can be constructed wherein the functionality of the battery charger and inverter is combined reducing the need for inclusion of one dc to dc conversion stage in the system and the associated components. In a grid connected wind turbine the need for batteries can also be eliminated.

### BRIEF DESCRIPTION OF THE DRAWINGS

Preferred embodiment will now be described, by way of example only, with reference to the accompanying drawings in which:

FIG. 1 shows a block schematic diagram of an embodiment of an electrical power generation apparatus;

FIG. 2 shows a block schematic diagram of an embodiment of an electrical power generation apparatus with batteries;

FIG. 3 shows a circuit schematic diagram, including electronic components, of an embodiment of an electrical power generation apparatus;

FIG. 4 shows a computer apparatus used to control an electrical power generation apparatus;

FIG. 5 shows a block schematic diagram of a boost converter controller, for producing control signals;

FIG. 6 shows a block schematic diagram of an inverter controller, for producing control signals; and

FIG. 7 shows a block schematic diagram of a braking resistor controller, for producing control signals.

### PREFERRED EMBODYMENT OF THE INVENTION

A new electrical power generation apparatus can be constructed though selecting standard AC motor drive circuits, commonly available as integrated modules, adding some additional components and applying appropriate reconfiguration. Further, electrical power generation apparatus can be constructed such that the functionality of the battery charger and inverter is combined without the need for inclusion of one dc to dc conversion stage in the system and the associated components. In a grid connected wind turbine the need for batteries can also be eliminated.

The preferred embodiment utilises standard AC motor drive circuits with a customised controller to operate as a low cost electrical power generation apparatus for use with a wind turbine. The preferred embodiment uses the standard AC motor drive power electronics and gate drive circuits obtained from a third party power electronics or drive manufacturer. It will be appreciated by those skilled in the art that this same electrical power generation apparatus can be constructed from discrete components or from other sources of power electronic components.

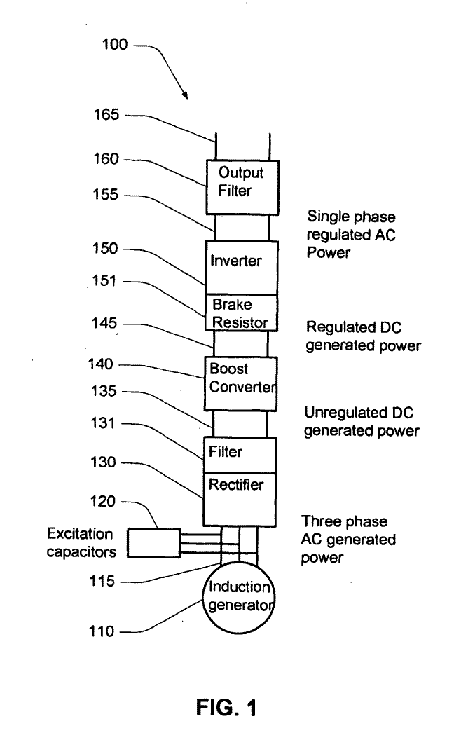

FIG. 1 shows a block schematic of an embodiment of an electrical power generation apparatus 100, including an induction generator 110, excitation capacitors 120, a rectifier 130 with filter 131, a boost converter 140, an inverter 150 with a brake resistor circuit 151 and an output filter 160. The induction generator 110 may be self-excited, requiring the excitation capacitors 120. The excitation capacitors 120 are optional, for example when the induction generator 110 employs permanent magnets for excitation. The induction generator 110 produces unregulated three-phase AC power 115. The voltages and frequency associated with the three-phase AC power 115 varies according to system variables, including wind speed and system load. The three-phase AC power 115 is passed into a rectifier 130 and filter 131 to produce unregulated DC power. The unregulated DC power is regulated by the boost converter 140 to produce controlled DC power 145. The boost converter 140 is configured to control the output direct current power 145 such that the DC voltage average over time intervals is nearly constant. The controlled DC power 145 is further applied to the inverter 150 to produce controlled single-phase AC power. The brake resistor circuit 151 assists in the management of power flows when the wind turbine power exceeds the load power requirement.

The brake circuit 151 serves a number of functions, including providing a controllable load for power matching and a mechanism for ensuring the boost converter stays in continuous conduction mode when the output load is light. In the event of excessive wind, a separate electromechanical brake is used to stop or slow the wind turbine. The controlled single-phase AC power may optionally be applied to an output filter 160. The output filter 160 attenuates harmonic components from the voltage output produced by the inverter.

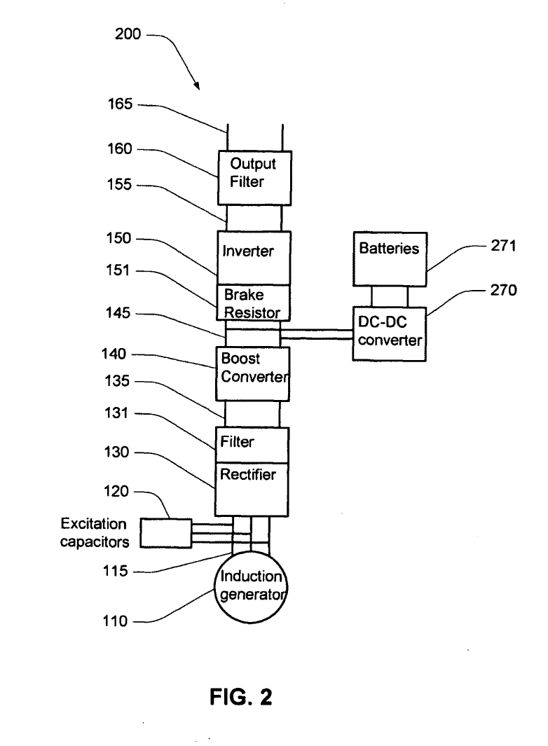

FIG. 2 shows a block schematic of an embodiment of an electrical power generation apparatus with batteries 200. The block schematic show that a bi-directional DC-DC converter 270 and batteries 271 can be connected to the controlled direct current power 145 across the output of the boost converter 140. Alternatively batteries may be directly connected to this point provided they are configured to support an appropriate voltage, typically series connected.

The electrical components used in constructing the embodiment of an electrical power generation apparatus and the operation of these electrical components will now be discussed in more detail. The relation to standard drive power electronics and gate drive circuits will also be highlighted. Construction of an electrical power generation apparatus utilises standard power electronic components in a standard ac motor drive, including a rectifier, dynamic braking circuit and inverter. In low power ratings these components are purchased most cost effectively as an integrated module from a semiconductor manufacturer. The proposal is to reconfigure these standard circuits to form an electrical power generation control system. This reconfigured circuit achieves the same functionality as the commonly used battery charger and inverter combination but at a significant cost advantage.

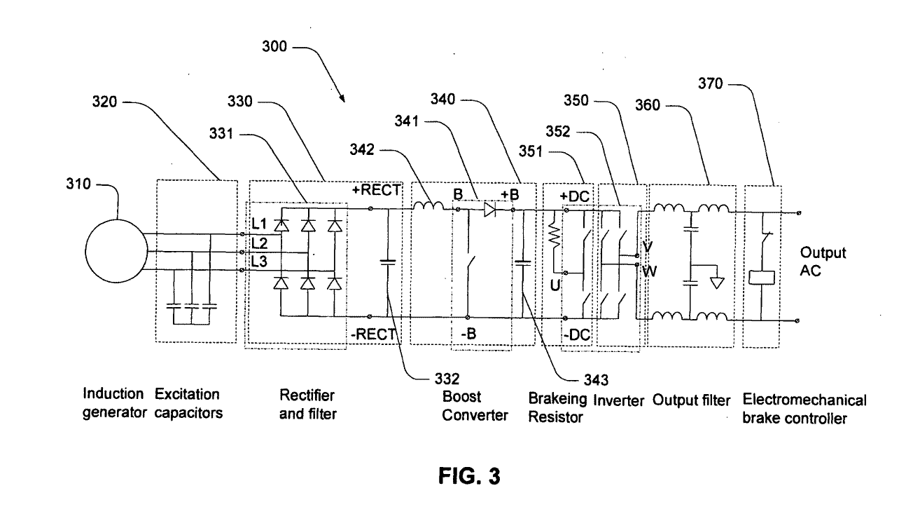

FIG. 3 shows a component circuit schematic of an embodiment of an electrical power generation apparatus 300, wherein this embodiment uses alternative numbering to previous embodiments. The component construction and functionality of this embodiment is now discussed in more detail.

### Induction Generator

The wind turbine mechanically drives a three-phase induction generator 310 operating as a generator of three-phase AC power. The magnitude and frequency of the three-phase AC power is dependant on the rotational speed of the induction generator rotor, wind conditions and load conditions. The induction generator may require excitation capacitors 320. Excitation capacitors typically consist of three capacitors connected in wye (or star) configuration at the generator terminals, allowing the generator to self excite when the turbine reaches an appropriate rotational speed. Excitation capacitors are not always necessary, for example when the induction generator is replaced with a permanent magnet generator.

### Rectifier and Filter

Rectifier and filter 330 comprises a three-phase bridge rectifier 331 and a capacitive filter 332. The rectifier 331 converts the variable magnitude variable frequency AC voltage at the generator terminals to a variable magnitude DC voltage. The filter 332 is included across the rectifiers output to reduce the ripple voltage in the output from the rectifier circuit to an appropriate level. In motor drive circuits, capacitors are used as standard, but series ‘inrush’ resistors accompany these capacitors to reduce the high current flow that occurs when input voltage is applied suddenly. In this application the build up of voltage from the generator is gradual, eliminating the need for ‘inrush’ resistors.

### Boost Converter

The Boost converter 340 can be constructed from a reconfigured dynamic braking portion of a standard motor drive circuit. The remaining components of the dynamic braking portion of a standard motor drive circuit are shown 341. The boost converter 340 further includes an inductor 342 and capacitor 343. The boost converter produces a controlled (‘constant’) DC voltage at its output. A boost converter controller is used to control the boost converter voltage output. The output voltage is measured and is controlled by adjusting the on/off ratio or duty cycle of the boost converter IGBT.

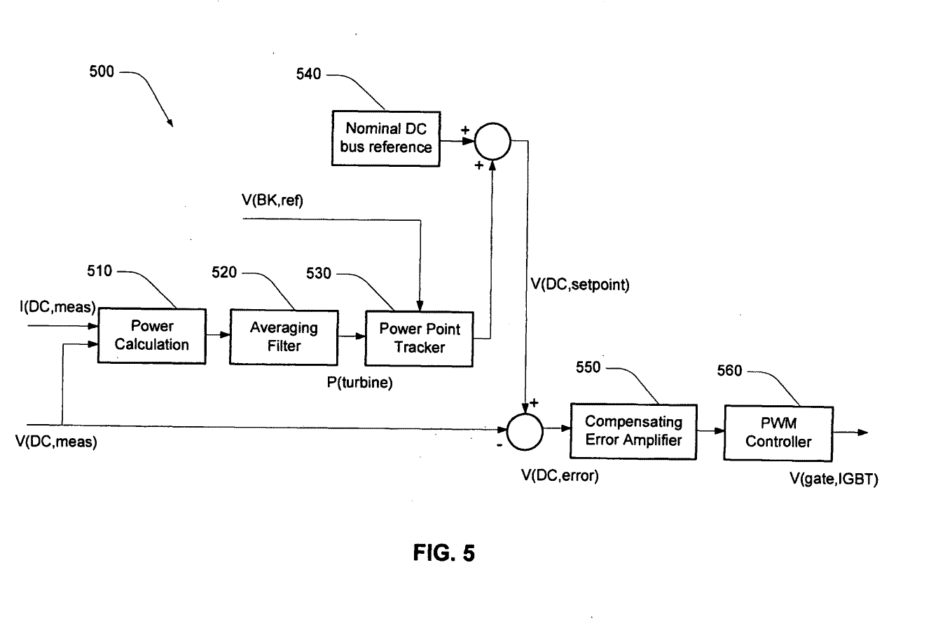

The boost converter controller 500 regulates the DC output voltage of the converter. Its functionality is shown in block diagram form in FIG. 5. The power is tracked by performing a power calculation 510 and applying an averaging filter 520 and performing a tracking operation by the power point tracker 530. A setpoint value (V_{DC,setpoint}) is generated by combining the nominal DC bus reference 340 and the output of the power tracker. This internally generated reference value (V_{DC,setpoint}) is compared with the measured output voltage (V_{DC,meas}) to produce an error value (V_{DC,error}). The error value is then applied to an error compensating amplifier 550. The error compensating amplifier improves the DC output voltage stability in response to transients caused by wind gusts and sudden load changes. The compensated error value then drives a PWM controller 560 for the boost converter IGBT gate drive.

The boost converter controller is also able to track the maximum power operating point for the wind turbine in given wind conditions. The turbines instantaneous output power is measured by calculating the product of the measured boost converter output voltage (V_{DC,meas}) and current (I_{DC,meas}), in the power calculator 510. This value is time averaged in an averaging filter 520. The power point tracker 530 algorithm incrementally adjusts the output voltage of the boost converter at regular intervals, while observing the change in average power. If the power is increased then the incremental change is retained. If the power is reduced the change is reversed for the next time interval. This method allows the maximum power operating point of the wind turbine to be tracked. A consequence of the power point tracking algorithm is that the boost converter output voltage can vary about its nominal value. This voltage variation is compensated for in the inverter control so that the AC output remains regulated to constant amplitude.

Within the power point tracker 530, the operation of the maximum power point tracking function is also modulated by the analog reference to the braking circuit (V_{BK,ref}). The braking function operates immediately in the short term to balance differences between the turbine and inverter output power. If the braking circuit is operating it will also signal the power point tracking algorithm to move the turbines operating point away from the optimal point over a longer time period to ultimately achieve power balance in that manner.

### Inverter

A single-phase AC inverter 350 and brake circuit 351 are constructed in part from a standard motor drive inverter circuit 352. Two legs of the standard motor drive inverter circuit are used to form a H-bridge inverter that produces a single-phase AC output with fixed magnitude and frequency, which is then filtered by an LC filter 360.

Alternatively the three legs of the motor drive inverter circuit could be configured as a three-phase inverter for three-phase grid-connection.

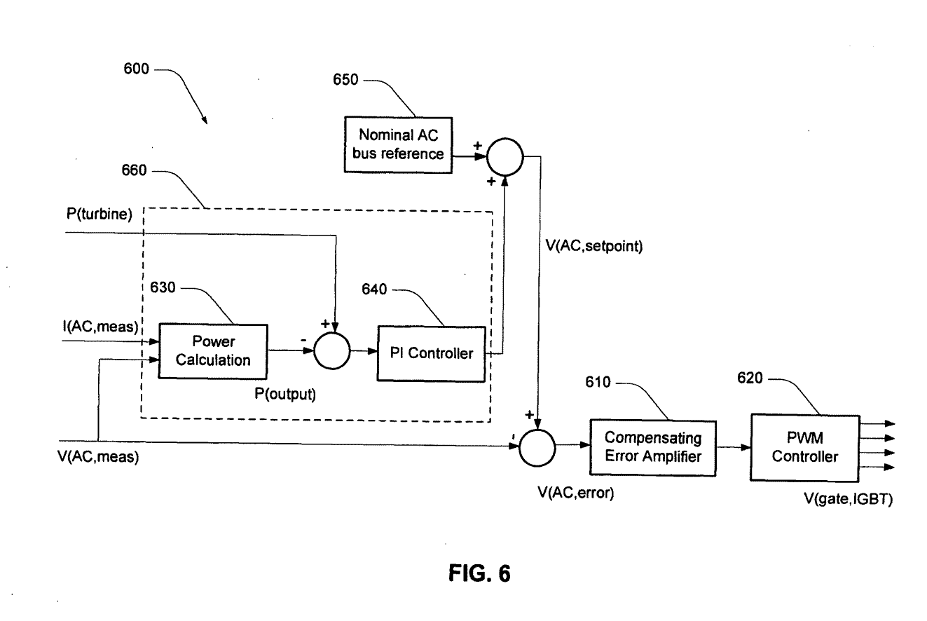

FIG. 6 shows the inverter controller 600 in block diagram form. The inverter controller generates gate signals to control the switching of the four Insulated Gate Bipolar Transistors (IGBT) that form the inverter H bridge. The inverter controller regulates the output voltage of the inverter by comparing the measured output voltage (V_{AC,meas}) with an internally generated reference value (V_{AC,setpoint}) to produce an error value (V_{AC,error}). This error is then applied to the compensating error amplifier 610. The compensating error amplifier improves the output voltage stability in response to transient loads. The compensated error value drives a PWM controller 630, which generates the gate drive signals (V_{gate,IGBT}).

If the inverter is connected to the grid additional functionality is added to the inverter controller as shown in FIG. 6. By way of example, functionality for grid connection 660 can include a power calculator 630 and a proportional-integral (PI) controller 640. The power calculator 630 calculates the power delivered to the grid from the magnitude and phase relationships between the measured AC output voltage (V_{AC,meas}) and current (I_{AC,meas}). This value is compared to the power being generated by the turbine (P_{turbine}) as calculated in the boost converter controller to produce an error value. This error value drives the proportional-integral (PI) controller 640, which varies the magnitude and phase of the AC setpoint so that all the turbine power is transferred to the grid.

### Braking Resistor

The braking resistor circuit 351 is constructed by placing a resistor across the remaining leg of the standard motor drive inverter circuit 352, as shown. This braking resistor circuit serves a number of functions. In the event that the combined electrical load of the batteries and external load connected to the controller is less than the power being generated by the wind turbine, it provides a controllable load for power matching. It also provides a mechanism for ensuring the boost converter stays in continuous conduction mode when the output load is light. In the event of excessive wind a separate electromechanical brake can be used to stop the wind turbine.

The braking resistor circuit preferably has a power rating equivalent to the maximum wind turbine output. A braking resistor controller controls the lower IGBT in the inverter leg with a pulse width modulated (PWM) signal. The upper IGBT in the inverter leg is not used, although its anti-parallel diode does provide a path for the braking resistor current when the lower IGBT is switched off.

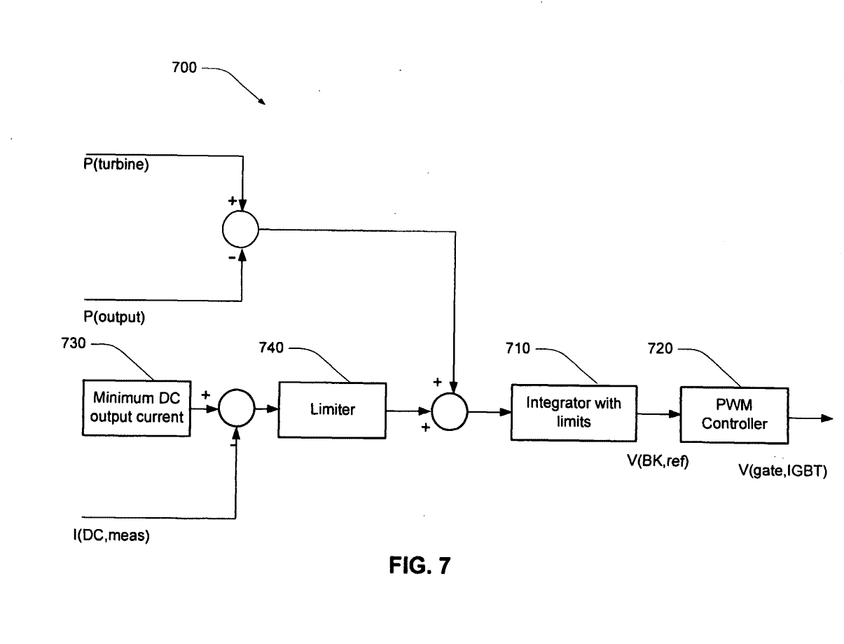

FIG. 7 shows the functional blocks in the braking resistor controller 700. The difference between the generated power from the turbine (P_{turbine}) and the output power from the inverter (Pₒᵤₜₚᵤₜ) is fed to an integrator with limits 710. The integrator integrates the power mismatch to generate the analog reference for the braking resistor's PWM controller 720. The limits on the integrator are set so that during periods where the wind turbine power generated is less than the combined electrical output load on the inverter the braking resistor is left disconnected by setting the duty cycle of the braking resistor PWM controller to zero. During periods where the wind turbines output power exceeds the electrical load the duty cycle is raised until the difference in electrical input and output power is applied to the braking resistor.

The braking resistor controller also acts to ensure the boost converter always operates in continuous conduction mode. The measured boost converter output current (I_{DC,meas}) is compared to the limit for maintaining continuous conduction 730. If the current falls below the limit a further value is applied to the integrator 710, which increases the value at the input of the PWM controller 720 and further increases the duty cycle of the output braking resistor PWM signal (V_{gate,IGBT}). This increases the electrical load on the output of the boost converter and forces it back into continuous operation. A limiter 740 prevents this circuit having any affect when the boost converter current is above the minimum value.

The braking resistor controller operates in the short term to restore power imbalances in the wind turbine controller. The power point tracking controller then acts over a longer time period to achieve power balance by moving the turbine away from its optimal operating point to achieve power balance through this mechanism.

### Output Filter

An LC filter 360 is used to filter switching harmonics from the output AC waveform. The inductor in the filter can also be used as interface impedance in a grid connected wind turbine controller. It will be appreciated by those skilled in the art that alternative filter arrangements may be used.

### Electromechanical Brake Controller

An electromechanical brake 370 may be included and powered from the AC power output of the wind turbine controller. Battery storage is required to power the brake open for an isolated wind turbine. For a grid connected turbine the grid power can be used to power the brake open and the battery storage component removed.

The brake is applied when the wind turbine is detected to be operating above its rated speed. Speed is approximated from a frequency measurement of the ac voltage supplied from the induction generator. In the event that the mechanical brake is applied the controller will release the brake periodically to test if generation can resume.

### Software Control

The method of electrical power generation control further requires controller algorithms implement in software or hardware, or both, to achieve effective power generation. The boost converter controller, inverter controller and break resistor controller have been described above and are shown in FIG. 5, FIG. 6 and FIG. 7 respecively.

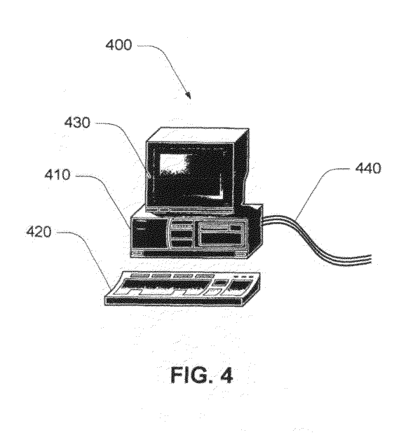

FIG. 4 shows an apparatus to control electrical power generation 400. The apparatus to control electrical power generation 400, comprising a processing system 410, keyboard as an input device 420, a monitor as an output device 430 and electrical connections 440 for transmitting control signals. Further, the input may be provided on a storage medium or via a computer network, input parameters may be pre-configured or entered at run time, the output signals may be displayed on a monitor or sent over a computer network. It will be appreciated by those skilled in the art that alternative or combinations of input devices or output devices are suitable for implementing alternative embodiments.

Preferably the processing system 410 is configured to monitor and control electrical power generation, including:
(a) Measure and control the boost converter switching signals to maintain a controlled DC voltage;
(b) Measure the controlled DC voltage and control the brake resistor switching signals;
(c) Measure the output AC waveform and control the inverter switching signals;
(d) Measure and control the integrated system behaviour to maximise power delivered from the wind turbine; and
(e) Measure the speed of the wind turbine and control the electromechanical brake.

It will be appreciated by those skilled in the art that this same electrical power generation apparatus is not limited to the described field of use. The method and apparatus can also be applied to any other power generation scenario that includes an induction or permanent magnet generator to convert mechanical to electrical power (e.g. water turbines, microturbines). Further, the method and apparatus not limited to the suggested power rating, but can be applied in any rating where standard motor drive power electronic components can be used.

It will be appreciated by those skilled in the art that this same electrical power generation apparatus and method can be used where other methods are selected to drive the induction motor. It will be further be appreciated by those skilled in the art that this same electrical power generation apparatus and method is suited to, but in no way limited to, applications where the force driving the induction motor is not constant and the consequences of this must be suitably controlled.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while a diagrams only shows a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that are for execution on one or more processors, e.g., one or more processors that are part of whatever the device is, as appropriate. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media, a medium bearing a propagated signal detectable by at least one processor of one or more processors and representing a set of instructions that when executed implement a method, a carrier wave bearing a propagated signal detectable by at least one processor of the one or more processors and representing the set of instructions a propagated signal and representing the set of instructions, and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Interpretation

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Similarly, it should be noted that the terms value and signal includes analog floating point and discrete amplitude, or quantised. Further the value or signal may be time continuous, time discrete or sampled. A person skilled in the art would recognise that the information associated with the value or signal can be appropriately transformed between representation to suit the source and sink of the value or signal.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method of electrical power generation including the steps of:
(a) receiving alternating current power in the form of alternating current generated from a power generation unit;
(b) rectifying said alternating current power to produce direct current power;
(c) controlling said direct current power to produce controlled direct current power of a predetermined direct current voltage level; and
(d) inverting said controlled direct current power to produce output alternating current.

2. A method of electrical power generation according to claim 1, further including the step of: applying a braking resistor to said controlled direct current power when said direct current power exceeds a predetermined level.

3. A method of electrical power generation according to claim 1, further including the step of: storing or supplying controlled direct current power through a bi-directional direct current to direct current converter, wherein the two ports of the bi-directional direct current to direct current converter are separately connected to batteries and said controlled direct current power.

4. A method of electrical power generation according to claim 1, further including the step of: filtering said produced output alternating current.

5. A method of electrical power generation according to claim 1, wherein said inverting controlled direct current is performed directly on said controlled direct current.

6. A method of electrical power generation control according to claim 1, when said power generation unit comprises a wind turbine.

7. (canceled)

8. An electrical power generator apparatus including:
a power generating means for generating an alternating current power source;
a rectifier module, coupled to said power generating means, for rectifying the alternating current power source to produce rectified current;
a boost converter module, coupled to said rectifier module for producing a direct current output of a predetermined direct current level; and
a single-phase inverter module, coupled to said boost converter module for producing an output alternating current from said predetermined direct current output.

9. An electrical power generator apparatus according to claim 8, wherein said boost converter module is constructed from a dynamic braking portion of a motor drive circuit.

10. An electrical power generator apparatus according to claim 8, wherein said single-phase inverter module is constructed from a standard motor drive inverter circuit.

11. An electrical power generator apparatus according to claim 8, further including a brake resistor.

12. An electrical power generator apparatus according to claim 10, further including a brake resistor, wherein said brake resistor is coupled to said standard motor drive inverter circuit.

13. An electrical power generator apparatus according to claim 8, further including an output filter for filtering out harmonics in said output alternating current.

14. An electrical power generation apparatus including:
a power generating means
a rectifier module;
a direct current controller module; and
an inverter module;
wherein said power generating means is coupled to said rectifier module and is configured to supply power in the form of input alternating current to said rectifier module; wherein said rectifier module is coupled to said direct current controller module and is configured to convert said input alternating current to unregulated direct current; wherein said direct current controller module is coupled to said inverter module and is configured to convert said unregulated direct current to regulated direct current; wherein said inverter module is configured to convert said regulated direct current to regulated alternating current.

15. An electrical power generation apparatus according to claim 14, wherein said modules substantially consist of standard alternating current motor drive modules.

16. An electrical power generation apparatus according to claim 14, when used to produce power from wind turbines.

17. An electrical power generation apparatus according to claim 14, wherein said power generating means is an induction generator.

18. An electrical power generation apparatus according to claim 17, wherein said induction generator is a wind turbine.

19. (canceled)
